(19) United States
(12) Patent Application Publication
(10) Pub. No.: US 2025/0245335 A1
(43) Pub. Date: Jul. 31, 2025

(54) SYSTEMS AND METHODS TO SAFELY PROVIDE FILES AND SOFTWARE UPDATES WITH A CLOUD SUBSCRIPTION SERVICE

(71) Applicant: Fortinet, Inc., Sunnyvale, CA (US)

(72) Inventors: Juan Ruiz Sanchez, Barcelona (ES); Jorge Garcia Alvarez, Barcelona (ES)

(73) Assignee: Fortinet, Inc., Sunnyvale, CA (US)

(21) Appl. No.: 18/427,252

(22) Filed: Jan. 30, 2024

(51) Int. Cl. G06F 21/57; G06F 8/65

(52) U.S. Cl. CPC G06F 21/572; G06F 8/65; G06F 2221/033

(57) ABSTRACT

A computer-implemented method includes building, with a network security platform, a trusted database having software including software updates and files including file information from trusted third party software providers. The computer-implemented method further includes receiving a software update or file from a third party software provider, determining an identifier for the software update or file, validating the software update or file to determine validity of the software update or file, and determining whether to update the trusted database with the identifier for the software update or file.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2024, Fortinet, Inc.

### FIELD

Embodiments discussed generally relate to systems and methods to safely provide files and software updates with a cloud subscription service.

### BACKGROUND

An important part of the software and applications downloaded from the internet everyday originate from well-known software provider. However, recent security attacks include malicious actors using search engine optimization (SEO) techniques to position trojanized software in the web searches to drive client devices of end users to download bad software or malware instead of the intended software download from the well-known software providers.

### SUMMARY

Various embodiments provide systems and methods for computing risk scores for entities (e.g., hosts, users) in a network. A computer-implemented method includes building, with a network security platform, a trusted database having software including software updates and files including file information from trusted third party software providers. The computer-implemented method further includes receiving a software update or file from a third party software provider, determining an identifier for the software update or file, validating the software update or file to determine validity of the software update or file, and determining whether to update the trusted database with the identifier for the software update or file.

In some embodiments, a system includes a processing resource and a non-transitory computer readable medium coupled to the processing resource and having stored therein instructions that when executed by the processing resource cause the processing resource to

build a trusted database having software including software updates and files including file information from trusted third party software providers, receive a software update or file from a third party software provider, determine a hash identifier for the software update or file, validate the software update or file to determine validity of the software update or file, and determine whether to update the trusted database with the hash identifier for the software update or file.

In some embodiments, a non-transitory computer readable medium having stored therein instructions that when executed by the processing resource cause the processing resource to build a trusted database having software including software updates and files including file information from trusted third party software providers, receive a software update or file from a third party software provider, determine a hash identifier for the software update or file, validate the hash identifier for the software update or file to determine validity of the software update or file, and determine whether to update the trusted database with the hash identifier for the software update or file.

This summary provides only a general outline of some embodiments. Many other objects, features, advantages, and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIG. 1 illustrates an exemplary network architecture 100 in accordance with one embodiment;

FIG. 2 is a block diagram 200 illustrating functional components of a network security platform 230 and an endpoint device 280 in accordance with one embodiment;

FIGS. 3A-3B illustrate operations of a computer implemented method for building a trusted database and handling of incoming files and updates with a network security platform in accordance with one embodiment;

FIG. 4 illustrates operations of a computer implemented method for building and integrating a trusted database with a network security platform in accordance with one embodiment;

FIG. 5 illustrates operations of a computer implemented method for processing an incoming file or software update from a third party software provider in accordance with one embodiment;

FIG. 6 illustrates operations of a computer implemented method for establishing a trusted database for software providers that provide software for devices in accordance with one embodiment; and

FIG. 7 illustrates an example computer system 160 in which or with which embodiments may be utilized.

### DETAILED DESCRIPTION

Various embodiments provide systems and methods to safely provide files and software updates with a cloud subscription service. Novel features of the present design enhance antivirus (AV) engines and data loss prevention mechanisms for network security devices.

The present design builds and automatically updates a trusted database of well-known files and software updates from trusted software providers. The trusted database is utilized to reduce time and processing resources needed to validate new files and software updates from software providers.

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The phrases “endpoint protection platform” or “endpoint security solution” generally refer to cybersecurity monitoring and/or protection functionality implemented on an endpoint device. In one embodiment, the endpoint protection platform can be deployed in the cloud or on-premises and supports multi-tenancy. The endpoint protection platform may include a kernel-level Next Generation AntiVirus (NGAV) engine with machine learning features that prevent infection from known and unknown threats and may leverage code-tracing technology to detect advanced threats such as in-memory malware. The endpoint protection platform may be deployed on the endpoint device in the form of a lightweight endpoint agent that utilizes less than one percent of CPU and less than 100 MB of RAM and may leverage, among other things, various security event classification sources provided within an associated cloud-based security service. Non-limiting examples of an endpoint protection platform include the Software as a Service (SaaS) enSilo Endpoint Security Platform and the FORTICLIENT integrated endpoint protection platform available from Fortinet, Inc. of Sunnyvale, Calif.

The term “event” generally refers to an action or behavior of a process, for example, running on an endpoint device. Non-limiting examples of events include file system events and operating system events. Events that may be initially classified as suspicious or malicious by a heuristic engine and/or a machine-learning engine employed by the endpoint protection platform, for example, may include an attempt to communication with a critical software vulnerability (CVE), an attempt to access the registry of the operating system, the network or the file system, an attempt by the process to copy itself into another process or program (in other words, a classic computer virus), an attempt to write directly to the disk of the endpoint device, an attempt remain resident in memory after the process has finished executing, an attempt to decrypt itself when run (a method often used by malware to avoid signature scanners), an attempt to binds to a TCP/IP port and listen for instructions over a network connection (this is pretty much what a bot—also sometimes called drones or zombies—do), an attempt to manipulate (copy, delete, modify, rename, replace and so forth) files that are associated with the operating system, an attempt to read the memory of sensitive programs, an attempt to hook keyboard or mouse (a/k/a key logging), an attempt capture a screen shot, an attempt to record sounds, and/or other behaviors or actions that may be similar to processes or programs known to be malicious. In one embodiment, events may be detected or intercepted by the endpoint protection platform hooking file system and/or operating system application programming interface (API) calls of interest and/or by leveraging a hypervisor to monitor the operating system.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform the one or more network functions. Other network devices may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance” or a network security device” that may reside within the particular network that it is protecting, or network security may be provided as a service with the network security device residing in the cloud. Such network security devices may include, but are not limited to, network firewall devices and/or network gateway devices. While there are differences among network security device vendors, network security devices may be classified in three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DOS attack detection and mitigation appliances).

The phrase “security event classification source” generally refers to a security service in the form of hardware, software or a combination thereof that is capable of contributing in whole or in part to a classification result for a given security event (e.g., as malicious, suspicious, a potentially unwanted program (PUP), inconclusive, likely safe or safe). Non-limiting examples of security event classification sources include various types of endpoint protection platforms/solutions, antivirus engines, static malware analysis engines, dynamic malware analysis engines, memory forensic engines, sandboxes, User and Entity Behavior Analytics (UEBA), Intrusion Detection Systems (IDSs), content inspection engines, distributed denial of service (DDoS) mitigation engines, machine-learning classifiers, file threat-feeds, Internet Protocol (IP)/uniform resource locator (URL) threat feeds, Indicators of compromise (IOC) threat feeds, file reputation services, IP/URL reputation services, vulnerability discovery services, Tactics Techniques and Procedures (TTPs) feeds, security events collected from another private network, EDR data, and the like. In one embodiment, some security event classification sources may be limited to classifying one or more specific artifacts of a given security event, while others may be capable of independently classifying a given security event and producing a classification result. For example, a hash feed that generates a hash of a file associated with an event may be capable of classifying the file and an IP or URL feed (e.g., an IP/URL threat feed or an IP/URL reputation service) may be capable of classifying an IP address or a URL associated with an event.

The phrase “network security platform” generally refers to one or more security event detection and/or classification sources that are used to protect a private network. The security event detection and/or classification sources of a network security platform may have knowledge of each other, communicate with each other, cooperate with each other to facilitate classification of observed security events and otherwise create synergies and improve the overall protection provided to the private network against cybersecurity threats. Alternatively or additionally, the security event classification sources participating within a network security platform may be under common control of a management service or device. A network security platform may include security event classification sources from the same or different parties (e.g., manufacturers and/or service providers) and the participating security event classification sources may reside or operate within different computing environments. For example, some of the participating security event classification sources may be implemented in physical form as part of an on premises solution and others may be implemented as services or in virtual form within a cloud-based environment (e.g., a cloud-based security service (e.g., the enSilo Cloud Service or FORTIGUARD security services available from Fortinet, Inc.) or within a third-party cloud provider), Non-limiting examples of a network security platform include one or more network security devices, network appliances, and/or endpoint protection platforms that are part of a cooperative security fabric (e.g., the Fortinet Security Fabric) and one or more network security services implemented within a cloud-based security service or other public, private or hybrid cloud environment. While in the context of various examples described herein, for sake of simplicity and brevity, a network security platform is described as including an endpoint protection platform running on an endpoint device of a private network, those skilled in the art will appreciate embodiments of the present disclosure are applicable to network security platforms including and a sandbox service and/or different security event detection/classification sources.

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

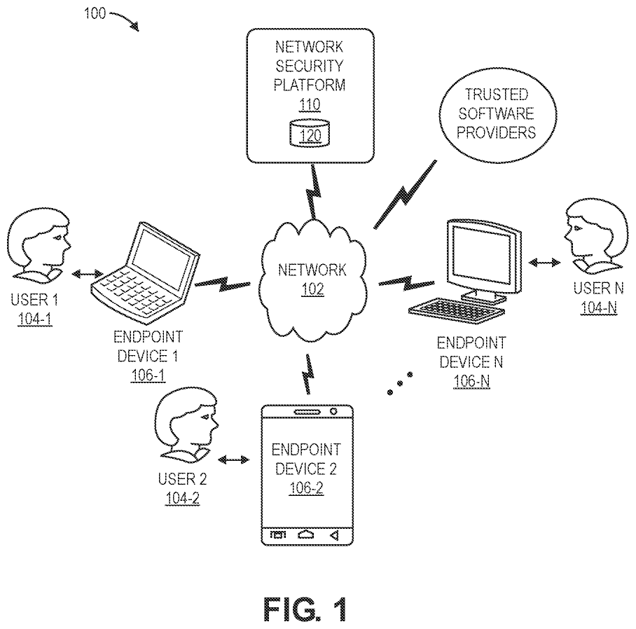

FIG. 1 illustrates a network architecture 100 in which aspects can be implemented in accordance with one embodiment. In the context of network architecture 100, a network security platform 110, protecting a private network 102 is accessible to endpoint devices 106-1, 106-2, . . . , 106-N of private network 102. Network security platform 110 may include a cloud-based security service in which a sandbox service resides as well as an endpoint security solution running on the endpoint devices 106. The cloud-based security service may be implemented within a public cloud, a private cloud or a hybrid cloud. Non-limiting examples of a cloud-based security service include the enSilo Cloud Service and FORTIGUARD security services available from Fortinet Inc.

The endpoint devices 106-1, 106-2, . . . 106-N (which may be collectively referred to as endpoint devices 106, and may be individually referred to as endpoint device 106 or endpoint device 106 herein) associated with network 102 may include, but are not limited to, personal computers, smart devices, web-enabled devices, hand-held devices, laptops, mobile devices, and the like. In one embodiment, network security platform 110 may interact with users 104-1, 104-2 . . . 104-N (which may be collectively referred to as users 104, and may be individually referred to as a user 104 herein) through network 102 via their respective endpoint devices 106, for example, in the form of notifications or alerts regarding security events via a user interface associated with the endpoint security solution.

Those skilled in the art will appreciate that, network 102 can be a wireless network, a wired network or a combination thereof that can be implemented as one of the various types of networks, such as an Intranet, a Local Area Network (LAN), a Wide Area Network (WAN), an Internet, and the like. Further, network 102 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

As described in further detail below, network security platform 110 can maintain a trusted database having software including files, software updates, URLs, etc. from trusted or verified third party software service providers. When endpoint device 106 attempts to execute a process that utilized files or software updates, prior to permitting execution of the process, the platform 110 determines whether the file(s) or software update from a third party software provider have an identifier that is stored in the trusted database. If so, additional security analysis of the file or software update is not needed.

However, if the identifier for the file(s) or software update is not stored in the trusted database 120, then an analysis based on a scan policy occurs. In one example, an endpoint security solution running on endpoint device 106, performs static analysis on files associated with the process to generate a static analysis score. In one embodiment, the static analysis score is generated by a machine-learning based model that has been trained based on numerous static properties/features associated with files and/or based on heuristic analysis based on signatures and rules, Non-limiting examples of static properties/features of files that may be used include file signature information (if it exists) (e.g., is the signature valid), file entropy, is the file packed (e.g., using the Ultimate Packer for executables (UPX), Thermida or the like), is the file a .NET file, does the file have debugger information associated with it, does the file have common section names, is the file using a known runtime library, is the file checksum correct, does the file entry point point to the code section, the modules that the file depends on, the time the file was compiled, suspicious strings within the file, and suspicious URLs within the file.

The static analysis threshold maintained by network security platform 110 can specify a threshold for a particular process to be considered malicious when compared to a particular score assigned to the particular process as a result of performing static file analysis on files associated with the particular process. Thus, network security platform 110 compares the static analysis score with the static analysis threshold and when the static analysis score meets or exceeds the static analysis threshold, then network security platform 110 treats the process as malicious (e.g., makes an initial classification of the process as malicious) and may take appropriate action to protect the endpoint device 106 (e.g., quarantining the file, notify the administrator, and/or block execution of the process). On the other hand, when the static analysis score is less than the static analysis threshold, the endpoint security solution also makes use of an additional analysis score for the process.

Those skilled in the art will appreciate that embodiments of the present design involve integration of multiple actions performed within network security platform 110, which may include actions within the cloud alone, the endpoint security solution alone or a combination of both.

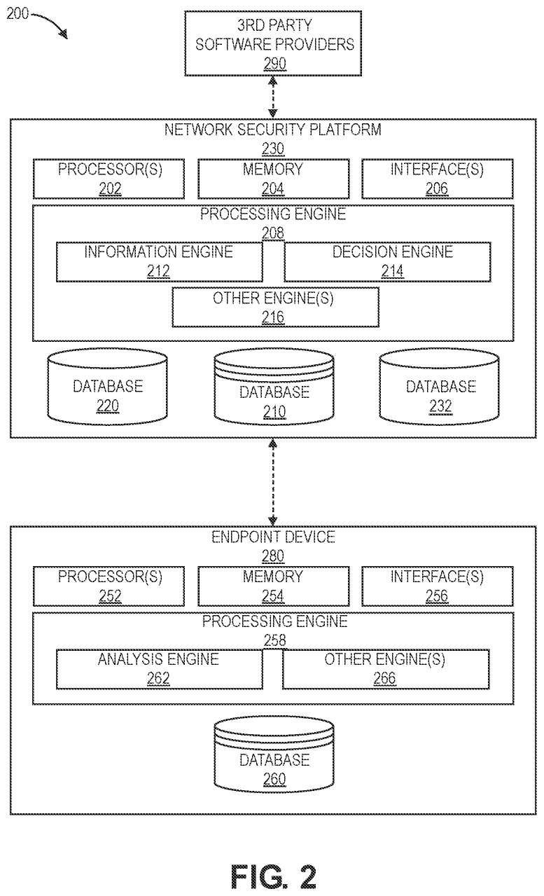

FIG. 2 is a block diagram 200 illustrating functional components of a network security platform 230 and an endpoint device 280 in accordance with one embodiment. In the context of the present example, network security platform 230 and endpoint device 280, can include one or more processor(s) 202 and 252 respectively. Processor(s) 202 and 252 can be implemented as one or more microprocessors, microcomputers, microcontrollers, digital signal processors, central processing units, logic circuitries, and/or any devices that manipulate data based on operational instructions. Among other capabilities, processor(s) 202 and 252 are configured to fetch and execute computer-readable instructions stored in

a memory 204 and 254 respectively. Memory 204 and 254 can store one or more computer-readable instructions or routines, which may be fetched and executed to create or share the data units over a network service. Memory 204 and 254 can include any non-transitory storage device including, for example, volatile memory such as RAM, or non-volatile memory such as EPROM, flash memory, and the like. In an example embodiment, memory 204 and 254 may be a local memory or may be located remotely, such as a server, a file server, a data server, and the Cloud.

Network security platform 230 and endpoint device 280 can also include one or more interface(s) 206 and 256 respectively. Interface(s) 206 and 256 may include a variety of interfaces, for example, interfaces for data input and output devices, referred to as I/O devices, storage devices, and the like to facilitate communication with various devices and functional components.

Processing engine(s) 208 and 258 can be implemented as a combination of hardware and software or firmware programming (for example, programmable instructions) to implement one or more functionalities of processing engine(s) 208 and 258. In the examples described herein, such combinations of hardware and software or firmware programming may be implemented in several different ways. For example, the programming for processing engine(s) 208 and 258 may be processor executable instructions stored on a non-transitory machine-readable storage medium and the hardware for processing engine(s) 208 and 258 may include a processing resource (for example, one or more processors), to execute such instructions. In the examples, the machine-readable storage medium may store instructions that, when executed by the processing resource, implement processing engine(s) 208 and 258. In such examples, network security platform 230 and endpoint device 280 can include the machine-readable storage medium storing the instructions and the processing resource to execute the instructions, or the machine-readable storage medium may be separate but accessible to network security platform 230, endpoint device 280 and the processing resource. In other examples, processing engine(s) 208 and 258 may be implemented by electronic circuitry. Databases 210, 220, 232, and 260 can include data that is either stored or generated as a result of functionalities implemented by any of the components of processing engine(s) 208 and 258 respectively.

In an example, processing engine 208 can include an information engine 212, a decision engine 214, and other engine(s) 216. Other engine(s) 216 can implement functionalities that supplement applications or functions performed by network security platform 230 or processing engine(s) 208.

In an example, processing engine(s) 258 can include an analysis engine 262, and other engine(s) 266. Other engine(s) 266 can implement functionalities that supplement applications or functions performed by endpoint device 280 or processing engine 258.

According to an embodiment, information engine 212 maintains information regarding a security scan policy for a particular process to be considered malicious when compared to a particular score assigned to the particular process as a result of performing file analysis on files associated with the particular process. The analysis of an incoming file or software update is only performed if an identifier of the incoming file or software update is not saved in the database 232 of the network security platform. The analysis based on the scan policy is not needed if the identifier of the incoming file or software update is saved in the database 232 and this saves processing time with faster classification of incoming files and software updates as being safe, likely safe, suspicious, or malicious.

Information engine 212 also monitors and updates an AV exemption database 220 and a trusted database 232 having files and software updates from trusted software providers. The AV exemption database 220 allows users to exempt known safe files that happen to be incorrectly classified as malicious from an AV signature and AV engine scan 217. The database 220 and trusted database 232 can be separate as shown in FIG. 2 or integrated.

The trusted database 232 can include file information such as size, publish date, risk score, vendor, brief software description, different hashes, and could be categorized in different categories and sub-categories. File versioning would also be possible to track file updates in an universal way commonly shared to the public. The third party software providers 290 can provide file information to interface(s) 206 of the network security platform for storing and organizing in the trusted database 232, which can include well known files, software updates, and Internet Protocol (IP)/uniform resource locator (URL) threat feeds.

The present design enhances a feature of having AV exemption database 220 by adding a subscription to provide trusted files and software updates that can be fed by main software companies in order to maintain the trusted database 232 of most downloaded files, like common operating system (OS) files and software updates. The new subscription provides a new feature to AV engines and data loss prevention mechanisms for network security devices.

Also, the present design of the network security platform based on this subscription would receive updates from App stores to be updated with new software and versions whenever the new software and versions are released. New hashes are generated for the new software and versions as released. In one example, once a new version of the database 232 is available, this version can be downloaded from FortiGuard to all required Fortinet products, like Fortigate, FortiMail, FortiProxy, Fortiweb, FortiClient, etc. This new subscription provides a service to allow third party software providers and application market places to publish trusted software to a solution front end of the network security platform and would serve as a global Internet reputation and trust place for well known files, software updates, etc.

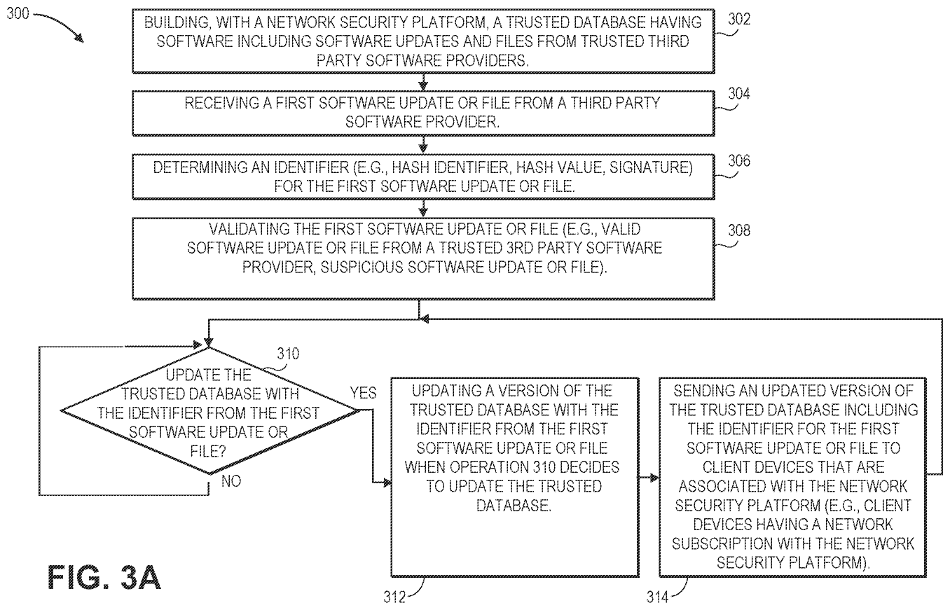

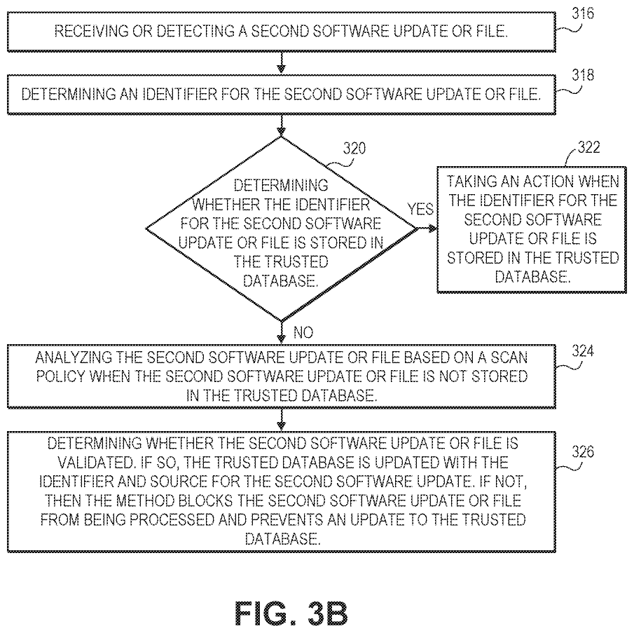

FIGS. 3A-3B illustrate operations of a computer implemented method for building a trusted database and handling of incoming files and updates with a network security platform in accordance with one embodiment. The operations of the method 300 can be performed by a processing resource of a network security platform, a network security appliance/device including a network gateway, a VPN appliance/gateway, a SIEM device, or UTM appliance (e.g., the FORTIGATE family of network security appliances).

At operation 302, the computer-implemented method includes building, with a network security platform, a trusted database having software including software updates and files and URLs from trusted third party software providers. At operation 304, the computer-implemented method includes receiving a first software update or file from a third party software provider.

At operation 306, the computer-implemented method includes determining an identifier (e.g., hash identifier, hash value, signature) for the first software update or file. At operation 308, the computer-implemented method includes validating the first software update or file to determine validity of the first software update or file (e.g., valid software update or file from a trusted 3^{rd} party software provider that is considered safe, suspicious software update or file, malicious software update or file, etc.). In one example, the first software update or file is validated with machine learning (ML) and static code validation (e.g., static file analysis). At operation 310, the computer-implemented method includes determining whether to update the trusted database with the identifier from the first software update or file.

At operation 312, the computer-implemented method includes updating a version of the trusted database with the identifier and file information (e.g., a file size, a publish date, a risk score, a software provider, a brief software description, and different hashes) for the first software update or file when operation 310 decides to update the trusted database, which will happen if the first software update or file is considered safe for processing. If no update to the trusted database, then the method returns to operation 310.

At operation 314, the computer-implemented method includes sending an updated version of the trusted database including the identifier for the first software update or file to client devices that are associated with the network security platform (e.g., client devices having a network subscription with the network security platform).

At operation 316 of FIG. 3B, the computer-implemented method includes receiving or detecting a second software update or file. At operation 318, the computer-implemented method includes determining an identifier for the second software update or file.

At operation 320, the computer-implemented method includes determining whether the identifier for the second software update or file is stored in the trusted database. At operation 322, the computer-implemented method includes taking an action (e.g., indicating that the second software update or file is safe, verified, etc.) when the identifier for the second software update or file is stored in the trusted database. Data packets for an incoming second software update or file of a device do not need to be inspected if the identifier is stored in the trusted database.

At operation 324, the computer-implemented method includes analyzing the second software update or file based on a scan policy for a network security platform when the second software update or file is not stored in the trusted database. At operation 326, the computer-implemented method includes determining whether the second software update or file is validated. If so, the trusted database is updated with the identifier and source for the second software update. If not, then the method blocks the second software update or file from being processed and prevents an update to the trusted database.

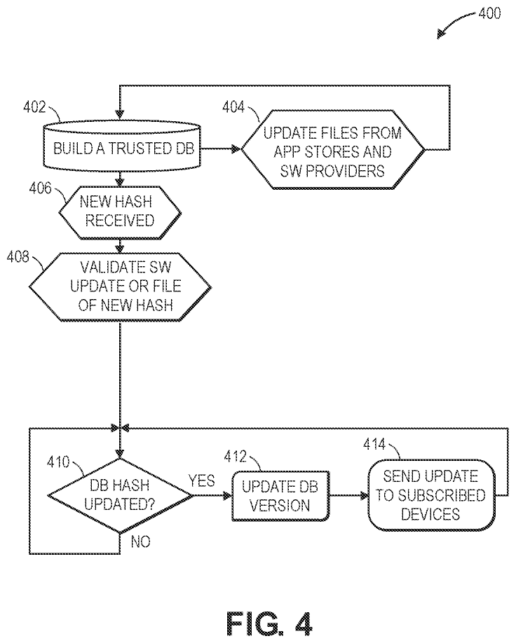

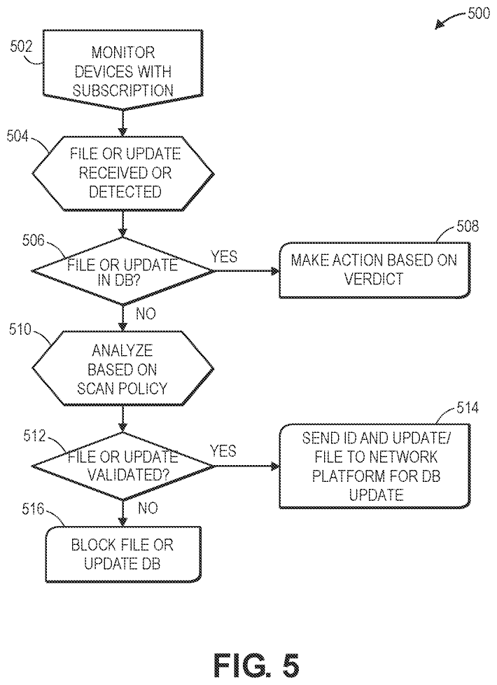

FIGS. 4 and 5 provide additional details for the operations of FIGS. 3A-3B. FIG. 4 illustrates operations of a computer implemented method for building and integrating a trusted database with a network security platform in accordance with one embodiment. The operations of the method 400 can be performed by a processing resource of a network security platform, a network security appliance/device including a network gateway, a VPN appliance/gateway, a SIEM device, or UTM appliance (e.g., the FORTIGATE family of network security appliances).

At operation 402, the computer-implemented method includes building, with a network security platform, a trusted database having software including software updates and files from trusted third party software providers. Application programming interfaces (APIs) of the network security platform allow communications between the network security platform and the trusted third party service providers. New files and software updates from trusted third party service providers are provided to the network security platform.

At operation 404, the computer-implemented method includes receiving, with the network security platform, a software update or file from a third party software provider.

At operation 406, the computer-implemented method includes determining an identifier (e.g., hash identifier, hash value, signature) for the software update or file. At operation 408, the computer-implemented method includes validating the software update or file associated with the identifier to determine validity of the software update or file (e.g., valid software update or file from a third party software provider, suspicious software update or file, etc.). In one example, the software update or file is validated with machine learning (ML) and static code validation (e.g., static file analysis). At operation 410, the computer-implemented method includes determining whether to update the trusted database with the identifier for the software update or file, which will happen if the software update or file is considered safe for processing. At operation 412, the computer-implemented method includes updating a version of the trusted database with the identifier and file information (e.g., a file size, a publish date, a risk score, a software provider, a brief software description, and different hashes) from the software update or file when operation 410 decides to update the trusted database. If no update to the trusted database, then the method returns to operation 410.

At operation 414, the computer-implemented method includes sending an updated version of the trusted database including the identifier for the software update or file to client devices that are associated with the network security platform (e.g., client devices having a network subscription with the network security platform).

FIG. 5 illustrates operations of a computer implemented method for processing an incoming file or software update from a third party software provider in accordance with one embodiment. The operations of the method 500 can be performed by a processing resource of a network security platform, a network security appliance/device including a network gateway, a VPN appliance/gateway, a SIEM device, or UTM appliance (e.g., the FORTIGATE family of network security appliances).

At operation 502, the computer-implemented method includes determining and monitoring devices (e.g., network devices, client devices) having an association with a network security platform. In one example, client devices or network devices having a network security subscription with the network security platform are determined and monitored.

At operation 504, the computer-implemented method includes receiving or detecting a software update or file from a third party software provider. The network security platform or devices being monitored by the platform receive the software update or file that has not yet been validated to determine whether the software update or file is safe or not for use and processing. At operation 506, the computer-implemented method includes determining an identifier (e.g., hash identifier, hash, signature, etc.) for the software update or file and whether the identifier is stored in the trusted database.

At operation 508, the computer-implemented method includes taking an action (e.g., validate the software update or file as being safe, allow a device to receive and process the software update or file, etc.) when the identifier for the software update or file is stored in the trusted database. The determination of whether the identifier is stored in the trusted database reduces an amount of time needed to determine whether the software update or file is safe, suspicious, or malicious because the file or software update do not need to be scanned for a security or virus risk.

At operation 510, the computer-implemented method includes analyzing the software update or file based on a scan policy of the network security platform when the software update or file is not stored in the trusted database. At operation 512, the computer-implemented method includes determining whether the software update or file is validated. If so, the trusted database is updated with the identifier and third party software provider for the file or software update at operation 514. If the file or software update is not validated at operation 512, then at operation 516 the method blocks the software update or file from being processed and prevents an update to the trusted database.

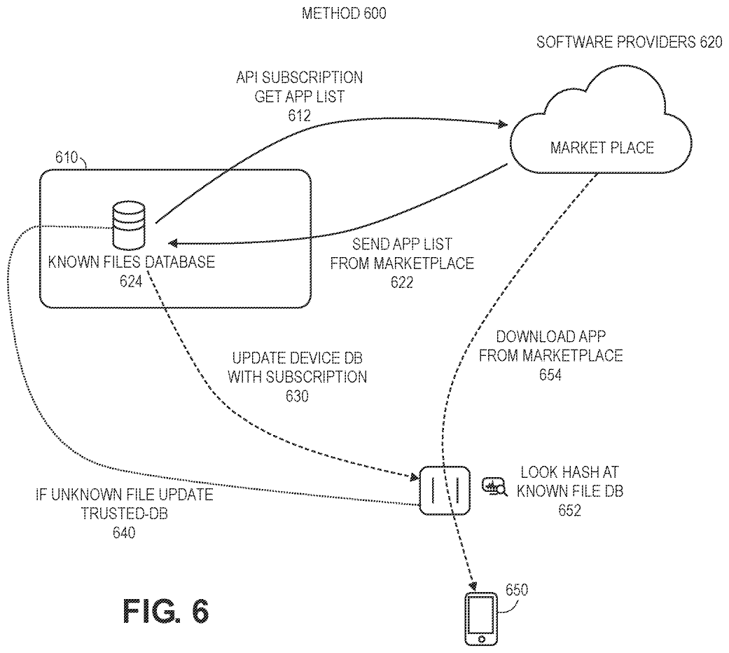

FIG. 6 illustrates operations of a computer implemented method for establishing a trusted database for software providers that provide software for devices in accordance with one embodiment. The operations of the method 600 can be performed by a processing resource of a network security platform, a network security appliance/device including a network gateway, a VPN appliance/gateway, a SIEM device, UTM appliance (e.g., the FORTIGATE family of network security appliances), or a client device.

At operation 612, the computer-implemented method includes establishing API subscriptions between a network security platform 610 and third party software providers 620 with one or more software providers providing an app marketplace or app store. The network security platform sends a request for an app list to one or more software providers having app marketplaces or app stores. In response, at operation 622, each software provider with an app marketplace or app store provides a list of apps to be trusted and stored in a trusted database 624 having known files and software updates. In one example, client devices or network devices (e.g., client device 650) having a network security subscription with the network security platform are determined and monitored. At operation 630, the known files and software updates of the trusted database 624 (or at least identifiers of the known files and software updates) are updated to a trusted database of the client device 650.

At operation 654, the client device 650 downloads an app from an app store or marketplace of a third party software provider 620. At operation 652, an identifier (e.g., hash, hash identifier, signature, etc.) for the app being downloaded is compared with identifiers in the trusted database of the client device. If trusted database includes the identifier for the app being downloaded, then the app is considered safe.

If the trusted database does not include the identifier, then at operation 640 the trusted database 624 can be updated with the identifier for an unknown file or software update if the identifier is validated as being safe.

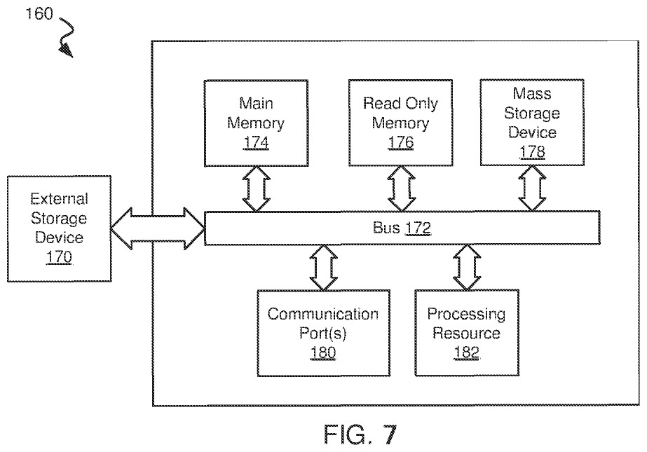

Turning to FIG. 7, an example computer system 160 is shown in which or with which embodiments may be utilized. As shown in FIG. 7, computer system 160 includes an external storage device 170, a bus 172, a main memory 174, a read-only memory 176, a mass storage device 178 having non-transitory computer readable medium, one or more communication ports 180, and one or more processing resources (e.g., processing circuitry 182). In one embodiment, computer system 160 may represent some portion of network element and/or network security appliance.

Those skilled in the art will appreciate that computer system 160 may include more than one processing resource 182 and communication port 180. Non-limiting examples of processing resources include, but are not limited to, Intel Quad-Core, Intel i3, Intel i5, Intel i7, Apple M1, AMD Ryzen, or AMD® Opteron® or Athlon MP® processor(s), Motorola® lines of processors, FortiSOC™ system on chip processors or other future processors. Processors 182 may include various modules associated with embodiments of the present disclosure.

Communication port 180 can be any of an RS-232 port for use with a modem-based dialup connection, a 10/100 Ethernet port, a Gigabit, 10 Gigabit, 25G, 40G, and 100G port using copper or fiber, a serial port, a parallel port, or other existing or future ports. Communication port 180 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read only memory 176 can be any static storage device(s) e.g., but not limited to, a Programmable Read Only Memory (PROM) chips for storing static information e.g., start-up or BIOS instructions for the processing resource.

Mass storage 178 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1300), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processing resource(s) with the other memory, storage and communication blocks. Bus 172 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such as front side bus (FSB), which connects processing resources to software systems.

Optionally, operator and administrative interfaces, e.g., a display, keyboard, and a cursor control device, may also be coupled to bus 172 to support direct operator interaction with the computer system. Other operator and administrative interfaces can be provided through network connections connected through communication port 180. External storage device 170 can be any kind of external hard-drives, floppy drives, IOMEGA® Zip Drives, Compact Disc-Read Only Memory (CD-ROM), Compact Disc-Rewritable (CD-RW), Digital Video Disk-Read Only Memory (DVD-ROM). Components described above are meant only to show various possibilities. In no way should the aforementioned example computer systems limit the scope of the present disclosure.

In conclusion, the present design provides for novel systems, devices, and methods to safely provide files and software updates with a cloud subscription service. While detailed descriptions of one or more embodiments of the present design have been given above, various alternatives, modifications, and equivalents will be apparent to those skilled in the art without varying from the spirit of the present design. Therefore, the above description should not be taken as limiting the scope of the present design, which is defined by the appended claims.

What is claimed is:

1. A computer-implemented method, comprising:
building, with a network security platform, a trusted database having software including software updates and files including file information from trusted third party software providers;
receiving a first software update or file from a third party software provider;
determining an identifier for the first software update or file;
validating the first software update or file to determine validity of the first software update or file; and
determining whether to update the trusted database with the identifier for the first software update or file.

2. The computer-implemented method of claim 1, further comprises:
updating the trusted database with at least one of the identifier and the first software update or file.

3. The computer-implemented method of claim 2, wherein the file information includes a file size, a publish date, a risk score, a software provider, a brief software description, and different hashes.

4. The computer-implemented method of claim 1, further comprises:
receiving or detecting a second software update or file; and
determining an identifier for the second software update or file.

5. The computer-implemented method of claim 4, further comprising:
determining whether the identifier for the second software update or file is stored in the trusted database.

6. The computer-implemented method of claim 5, further comprising:
taking an action when the identifier for the second software update or file is stored in the trusted database.

7. The computer-implemented method of claim 5, further comprises:
analyzing the second software update or file based on a scan policy when the identifier for the second software update or file is not stored in the trusted database.

8. A system comprising:
a processing resource; and
a non-transitory computer readable medium coupled to the processing resource and having stored therein instructions being executable by the processing resource cause the processing resource to:
build, with a network security platform, a trusted database having software including software updates and files including file information from trusted third party software providers;
receive a first software update or file from a third party software provider;
determine a hash identifier for the first software update or file;
validate the first software update or file using machine learning to determine validity of the first software update or file; and
determine whether to update the trusted database with the hash identifier for the first software update or file.

9. The system of claim 8, wherein the instructions being executable by the processing resource cause the processing resource to:
update the trusted database with the hash identifier from the first software update or file.

10. The system of claim 8, wherein the file information includes a file size, a publish date, a risk score, a software provider, a brief software description, and different hashes.

11. The system of claim 8, wherein the instructions being executable by the processing resource cause the processing resource to:
receive or detect a second software update or file; and
determine a hash identifier for the second software update or file.

12. The system of claim 11, wherein the instructions being executable by the processing resource cause the processing resource to:
determine whether the hash identifier for the second software update or file is stored in the trusted database.

13. The system of claim 12, wherein the instructions being executable by the processing resource cause the processing resource to:
take an action to consider the second software update or file safe when the hash identifier for the second software update or file is stored in the trusted database.

14. The system of claim 13, wherein the instructions being executable by the processing resource cause the processing resource to:
analyze the second software update or file based on a scan policy when the hash identifier for the second software update or file is not stored in the trusted database.

15. A non-transitory computer readable medium having stored therein instructions being executable by a processing resource cause the processing resource to:
build, with a network security platform, a trusted database having software including software updates and files including file information from trusted third party software providers;
receive a first software update or file from a third party software provider;
determine a hash identifier for the first software update or file;
validate the first software update or file using machine learning to determine validity of the first software update or file; and
determine whether to update the trusted database with the hash identifier for the first software update or file.

16. The non-transitory computer readable medium of claim 15, wherein the instructions being executable by the processing resource cause the processing resource to:
update the trusted database with the hash identifier from the first software update or file.

17. The non-transitory computer readable medium of claim 16, wherein the file information includes a file size, a publish date, a risk score, a software provider, a brief software description, and different hashes.

18. The non-transitory computer readable medium of claim 17, wherein the instructions being executable by the processing resource cause the processing resource to:
receive or detect a second software update or file; and
determine a hash identifier for the second software update or file.

19. The non-transitory computer readable medium of claim 18, wherein the instructions being executable by the processing resource to:
take an action to consider the second software update or file safe when the hash identifier for the second software update or file is stored in the trusted database.

20. The non-transitory computer readable medium of claim 19, wherein the instructions being executable by the processing resource to:
analyze the second software update or file based on a scan policy when the hash identifier for the second software update or file is not stored in the trusted database.
